(19) United States
(12) Patent Application Publication
(10) Pub. No.: US 2011/0311718 A1
(43) Pub. Date: Dec. 22, 2011

(54) METHOD OF MANUFACTURING THIN-FILM DIELECTRICS AND CAPACITORS ON METAL FOILS

(75) Inventors: Cengiz Ahmet Palanduz, Durham, NC (US); Allan Beikmohamadi, Cary, NC (US); Juan Carlos Figueroa, Wilmington, DE (US); David Ross McGregor, Apex, NC (US); Damien Francis Reardon, Wilmington, DE (US); Richard Ray Traylor, Angier, NC (US)

(73) Assignee: E.I. DU PONT DE NEMOURS AND COMPANY, Wilmington, DE (US)

(21) Appl. No.: 12/968,328

(22) Filed: Dec. 15, 2010

Related U.S. Application Data
(60) Provisional application No. 61/287,262, filed on Dec. 17, 2009.

(51) Int. Cl. B05D 5/12

(52) U.S. Cl. 427/80; 427/126.3

(57) ABSTRACT

Disclosed is a method of making a thin-film dielectric, comprising providing a base metal foil, forming a barium titanate-based dielectric precursor layer over a base metal foil, pre-annealing the dielectric precursor layer and base metal foil, rapidly heating the pre-annealed dielectric precursor layer from a temperature of less than 530° C. to an annealing temperature of more than 800° C. in less than 15 seconds; and annealing the dielectric to form a crystalline barium titanate-based dielectric on the base metal foil, wherein the crystalline barium titanate-based dielectric has grains with an average grain size that is greater or equal to 50 nanometers. Also disclosed is a method of making a capacitor comprised of the thin-film dielectric formed on a base metal foil according to the method described above with a second conductive layer formed over the dielectric.

### TECHNICAL FIELD

The present invention pertains to capacitors that may be embedded in printed wiring boards, and more particularly to capacitors that include a thin-film dielectric formed on a metal foil.

### RELATED ART

Semiconductor devices including integrated circuits (IC) are operating at increasingly higher frequencies and higher data rates and at lower voltages. The need to reduce noise in the power and ground (return) lines and the need to supply sufficient current to accommodate the faster circuit switching have become increasingly important. In order to provide stable power with low noise to the IC, low impedance in the power distribution system is required. The higher operating frequencies (higher IC switching speeds) mean that voltage response times to the IC must be faster. Lower operating voltages require that allowable voltage variations (ripple) and noise be small. For example, as a microprocessor IC switches and begins an operation, it calls for power to support the switching circuits. If the response time of the voltage supply is too slow, the microprocessor will experience a voltage drop or droop that will exceed the allowable ripple voltage and noise margin and the IC will trigger false gates. Additionally, as the IC powers up, a slow response time will result in power overshoot.

Power droop and overshoot are maintained within the allowable limits by the use of capacitors that provide or absorb power in the appropriate response time. Capacitors are generally placed as close to the IC as possible to improve their performance. In conventional circuits, impedance has been reduced by the use of surface mount technology (SMT) capacitors interconnected in parallel. Conventional designs have capacitors surface mounted on the printed wiring board (PWB) clustered around the IC. Large value capacitors are placed near the power supply, mid-range value capacitors at locations between the IC and the power supply and small value capacitors very near the IC. Large numbers of capacitors, interconnected in parallel, are often needed to reduce power system impedance. The complex electrical routing of the PWB has parasitic loop inductance. As IC operating frequencies increase and operating voltages drop, higher capacitance has to be supplied at increasingly lower inductance levels.

High capacitance density, thin-film ceramic capacitors can be embedded in the PWB package onto which an IC is mounted. A single layer ceramic capacitor embedded in the PWB under the IC can reduce the inductance and provide the capacitance necessary to satisfy the IC requirements. Such an embedded capacitor can provide capacitance with a significantly quicker response time and lower inductance than surface mounted capacitors. Such capacitors may be initially formed on metal foils by depositing a capacitor dielectric material on the foil and firing it at an elevated temperature. A top electrode is formed on the dielectric to form a fired-on-foil capacitor structure. The foil is then bonded to an organic laminate structure to create an inner layer panel wherein the capacitor is embedded in the panel. The inner layer panel is then stacked with other inner layer panels and connected by interconnection circuitry, and the stack of panels form a multi-layer printed wiring board. U.S. Pat. App. 2009-0238954-A describes methods for making thin-film capacitors with a barium-titanate based dielectric formed on a metal foil, and U.S. Pat. App. 2008-0316723-A1 describes a process for embedding thin-film capacitors into PWB packages.

Embedded capacitors in printed wiring boards cannot be replaced if they are defective as is possible with surface mounted capacitors. Accordingly, close to 100% embedded capacitor yield is required for each printed wiring board to function as designed. If one embedded capacitor in the printed wiring board does not function, it is likely that the board will have to be discarded. Achieving 100% embedded capacitor yield is especially troublesome where it is desirable for a large number of embedded capacitors to occupy the area under a semiconductor such as an IC mounted on the printed wiring board. A single IC may require hundreds of embedded capacitors.

In order to produce a barium titanate (BaTiO₃) based dielectric with a high dielectric constant, the dielectric must be annealed at a high temperature of 800° C. or more. However, during the heating up phase of the annealing process, crystallization of the barium titanate-based dielectric is initiated at relatively low temperatures such that numerous crystals at numerous nucleation sites are generated. This creates micro-crystalline grains which do not substantially grow during the annealing process. When the crystal grains remain small throughout the annealing process, high dielectric constants over significant areas are not obtained.

There is a need for a process for forming a barium titanate-based dielectric in which the dielectric is annealed at high temperatures and wherein significant crystal grain growth is obtained. There is also a need for process by which large numbers of high capacitance density embedded capacitor units with 100% yield can be obtained from large area barium titanate-based dielectrics with an area of 1 cm² or more that are formed on a base metal foil. There is also a need for a process for forming thin-film capacitors with barium titanate-based dielectrics wherein the desired grain growth necessary for achieving a high capacitance density is achieved.

### SUMMARY

Disclosed herein is a method of making a thin-film dielectric, comprising providing a base metal foil, forming a barium titanate-based dielectric precursor layer over a base metal foil, pre-annealing the dielectric precursor layer and base metal foil at a temperature in the range of 300° C. to 530° C., rapidly heating the pre-annealed dielectric precursor layer from a temperature of less than 530° C. to an annealing temperature of more than 800° C. in less than 15 seconds; and annealing the dielectric at the annealing temperature of more than 800° C. to form a crystalline barium titanate-based dielectric on the base metal foil, wherein the crystalline barium titanate-based dielectric has grains with an average grain size that is greater than 50 nanometers. In rapid heating of the pre-annealed dielectric may occur at a heating rate in the range of 100° C. per second to 200° C. per second. The pre-annealed dielectric precursor layer may be rapidly heated from a temperature of less than 530° C. to an annealing temperature of more than 800° C. in less than 10 seconds, and more preferably less than 5 seconds, and more preferable in a period in the range of from 1 to 3 seconds. In one embodiment, the annealing is conducted in a vacuum atmosphere having an oxygen partial pressure of less than about 10⁻⁶ atmospheres. The annealing temperature is typically in the range of 800° C. to 1200° C. and the annealing period is typically in the range of 10 to 30 minutes.

In one embodiment of the invention, the base metal foil is a metal foil having a nickel surface. In a disclosed embodiment, the dielectric precursor layer is formed by coating a surface of the base metal foil with a dielectric precursor solution comprising barium isopropoxide or barium acetate or barium propionate (Ba(CH₃—CH₂—COO)₂) and titanium isopropoxide or titanium butoxide or acetylacetone stabilized titanium butoxide (Ti(BuO)₂ (acac)₂). In another disclosed embodiment, after pre-annealing of the dielectric precursor layer, an additional dielectric precursor layer is formed over the pre-annealed dielectric precursor layer, and the additional dielectric precursor layer is pre-annealed at a temperature in the range of 300° to 530° C. The thin-film dielectric made by the disclosed method has a thickness of less than 2 microns. The thin-film dielectric is preferably comprised of crystalline barium titanate or crystalline barium strontium titanate. The thin-film dielectric may have an area of greater than 1 cm², and more preferably greater than 4 cm², or greater than 10 cm², or even greater than 25 cm², as for example a dielectric area in the range of 4 to 125 cm².

Also disclosed is a method of making a capacitor comprised of the thin-film dielectric formed on a base metal foil according to the method described above. A second conductive layer is formed over the dielectric, wherein the metal foil, the dielectric, and the second conductive layer form the capacitor. A plurality of separate second conductive layer electrodes may be formed on the large area dielectric so a to form multiple capacitors.

### BRIEF DESCRIPTION OF THE DRAWINGS

The detailed description will refer to the following drawings, wherein like numerals refer to like elements, and wherein:

FIG. 1 is a block diagram of a method suitable for forming a capacitor on metal foil according to the methods disclosed herein.

FIG. 2 is a scanning electron microscope picture of the surface of the rapid thermal annealed dielectric film showing grain size.

### DETAILED DESCRIPTION

### Definitions

The following definitions are used herein to further define and describe the disclosure.

As used herein and recited in the claims, the term “a” includes the concepts of “at least one” or “one or more than one”.

As used herein, the term “plurality” means more than one.

As used herein, “thin-film dielectric” refers to a dielectric having a thickness of less than 2 micrometers (microns) that is deposited by a thin-film deposition process such as sputtering, laser ablation, chemical vapor deposition, or chemical solution deposition (CSD) of a dielectric precursor.

As used herein, “thin-film capacitor” refers to a capacitor having a thin-film dielectric.

As used herein, “drying” refers to removing the solvent from a deposited dielectric precursor solution. Drying may be achieved by heating the deposited precursor solution to a temperature of between approximately 100° C. and 300° C. to effect solvent removal.

As used herein, “base metal foil” refers to metal foils that do not comprise precious metal and as such, will oxidize if subjected to elevated temperatures under ambient conditions.

As used herein, “pre-annealing” refers to heating or baking dielectric precursor layers for a short period of time at a temperature sufficient to remove the organic content of the dielectric precursor by decomposition, hydrolysis and/or pyrolysis, which temperature is below the temperature at which crystallization occurs.

As used herein, the terms “firing”, “annealing” and “sintering” are interchangable and refer to processing the dielectric at an elevated temperature, such as greater than 700° C.

As used herein, the term “fired-on-foil thin-film capacitors” refers to capacitors that are formed by: (1) firing at an elevated temperature a dielectric precursor layer deposited onto a metallic foil in order to crystallize and sinter the dielectric, which forms a high dielectric constant thin-film; and (2) depositing a top electrode before or after firing the dielectric.

As used herein, the terms “high dielectric constant”, “high Dk” and “high permittivity” are interchangeable and refer to dielectric materials that have a bulk dielectric constant above 500.

As used herein, “capacitance density” refers to the measured capacitance of a capacitor divided by the common area of the electrodes of the capacitor. Capacitance density is related to the dielectric constant by the relationship:

C/A=0.885K/t

where C/A is the capacitance density in nano Farads (nF) divided by the common electrode area expressed in square centimeters (cm²); K is the dielectric constant; t is the dielectric thickness in micrometers (microns); and 0.885 (nF·μm/cm²) is a constant (permittivity of free space) with re-adjusted units.

As used herein, the term “common area of first and second electrodes” refers to the overlapping area of both the first and the second electrode of a capacitor and is used to calculate the capacitance from the formula C/A=0.885 K/t.

As used herein, “normalized insulation resistance” refers to the measured insulation resistance of the capacitor multiplied by the common area of the electrodes of the capacitor. The units of normalized insulation resistance would be Ohm.cm².

As used herein, the term “printed wiring board” or “printed wiring board device” [PWB] refers to an interposer, multichip module, area array package, semiconductor package, system-on-package, system-in-package, and the like, or a device used as such.

As used herein, “embedded” refers to incorporating an electronic part, such as a capacitor, into a printed wiring board.

As used herein, the term “integrated circuit” (IC) refers to a semiconductor chip, for example, a microprocessor, a transistor set, logic device, etc.

As used herein, “average grain size” is measured according to the following intercept method: a micrograph of a cross-section or the surface of the dielectric is taken using a scanning electron microscope (SEM). Average grain sizes are determined by drawing several lines across the SEM micrograph and then counting the grain boundary intercepts with each line. The length of the lines on the micrographs (L) and the number of grain boundary intercepts with the lines (I) is used to calculate an average grain size by the formula:

Avg. grain size=(L)/(I-1).

Disclosed herein is a method of making a thin-film dielectric on a base metal foil. The disclosed method comprises the steps of providing a base metal foil and forming a dielectric precursor layer over the foil. The dielectric precursor layer is dried and pre-annealed. The pre-annealed dielectric precursor layer and base metal foil are rapid thermal annealed as more fully described below.

Amorphous barium titanate-based dielectric compositions have a relatively low dielectric constant (K) of approximately 20, and have to be fired at high temperatures to induce crystallization and produce the desired high K phase. High K phase in barium titanate-based dielectrics can be achieved when average crystalline grain size exceeds 50 nanometers, but are better achieved when average crystalline grain size exceeds 100 nanometers (0.1 micrometer) and so annealing temperatures over 800° C. are necessary.

It is preferable to have at least 5 dielectric grains between the first and second electrode of a thin-film capacitor for reliability reasons. Therefore, for a 1 micrometer thick dielectric, optimum grain size to realize high capacitance and good reliability is between 100 and 200 nanometers (0.1-0.2 micrometers). For a 2 micrometer thick dielectric, the optimum grain size range can be expanded to 100 nanometers to 400 nanometers to maintain the number of grains between the two electrodes.

The annealed dielectric exhibits an average grain size in excess of 50 nanometers measured according to the intercept method using surface SEM micrographs resulting in high capacitance density and high insulation resistance. In one embodiment of the disclosed method, the annealing results in a dense dielectric comprising crystalline barium titanate having an average capacitance density of approximately 2 micro Farads per square centimeter (μF/cm²) and a normalized insulation resistance of greater than 1×10⁷ ohms.cm².

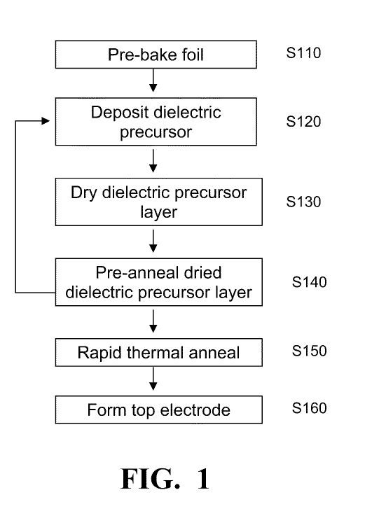

FIG. 1 is a block diagram showing a method suitable for forming a capacitor according to the disclosed method. In step S110, a base metal foil is provided. The base metal foil may be of a type generally used in the production of fired on foil capacitors. For example, the foil may be copper (Cu) or its alloys, copper-invar-copper, invar, nickel (Ni), nickel-coated copper or stainless steel, or other base metals or metal alloys that have melting points in excess of the annealing temperature for barium titanate-based thin-film dielectrics. The metallic foil serves as a substrate on which the dielectric is built, and it also serves as a “bottom” electrode in a finished capacitor. Preferred base metal foils include foils comprised predominantly of copper or nickel. Preferred base metal foils are freestanding foils with two opposite surfaces. The thickness of the foil may be in the range of, for example, between 1 and 100 micrometers, preferably between 3 and 75 micrometers, and more preferably between 12 and 36 micrometers. A preferred foil is a metallic foil with a nickel surface and may comprise pure nickel, nickel coated copper, or nickel coated steel, for example. An example of a suitable nickel foil is Nickel Foil 270 obtainable from Hamilton Precision Metals.

If the metallic foil is received from the vendor in clean condition, is carefully handled, and is promptly used, cleaning may not be necessary and the bare untreated metallic foil may be suitable for use in the disclosed method. Alternatively, the metal foil may be cleaned. Cleaning may be accomplished by use of a solvent, such as isopropanol. The foil may also be cleaned by briefly etching the foil, as for example by etching a copper foil for 30 seconds in a dilute solution of copper chloride in hydrochloric acid. The etching solution may be diluted approximately 10,000 times from its concentrated form. The cleaning process removes any excess oxide layer, fingerprints and other accumulated foreign matter from the foil. The foil is preferably not treated with organic addititves, which are sometimes applied in order to enhance adhesion of a metallic substrate to epoxy resins, because the organic additives may degrade the dielectric. The nickel surface of the base metal foil may be optionally polished by mechanical or electrochemical means.

In step S110, the base metal foil is pre-baked. Pre-baking removes adsorbed moisture and other adsorbed volatile solvents and may be accomplished in air at a temperature of between 150° C. and 300° C. for about two to ten minutes.

In step S120, a dielectric precursor solution is deposited over the base metal foil. The coating process typically deposits a dielectric precursor layer of approximately 50-150 nanometers in thickness. Preferred dielectrics are comprised of materials with high dielectric constants such as perovskites of the general formula ABO₃ in which the A site and B site can be occupied by one or more different metal cations. For example, high K is realized in crystalline barium titanate (BT), lead zirconate titanate (PZT), lead lanthanum zirconate titanate (PLZT), lead magnesium niobate (PMN) and barium strontium titanate (BST). In the method of the invention described herein, barium titanate-based materials such as BT or BST are used for the dielectric layer because these materials have high dielectric constants and are lead free.

Tetravalent metal cations such as zirconium (Zr), hafnium (Hf), tin (Sn) and cerium (Ce) having the preferred oxide stoichiometry of MO₂ may partially substitute for titanium in the BT dielectric material. These metal cations smooth the temperature-dependence of permittivity in the dielectric by “pinching” (shifting) the three phase transitions of BaTiO₃ closer to one another in temperature space. Divalent cations having the preferred oxide stoichiometry of MO, where M is an alkaline earth metal (e.g., calcium [Ca], strontium [Sr] or magnesium [Mg]), may partially substitute for barium as these can shift the dielectric temperature maxima to lower temperatures, further smoothing the temperature-dependent response of the dielectric.

Dopant cations may be also be added to the barium titanate to modify the dielectric characteristics. For example, small quantities of dopant rare earth cations having the preferred oxide stoichiometry of R₂O₃, where R is a rare earth cation (e.g., yttrium [Y], holmium [Ho], dysprosium [Dy], lanthanum [La] or europium [Eu]) may be added to the composition to improve insulation resistance and reliability of the resulting dielectric. Small atomic radii cations of the oxide stoichiometry MO such as calcium (Ca), or magnesium (Mg) as well as transition metal cations such as nickel (Ni), manganese (Mn), chromium (Cr), cobalt (Co) or iron (Fe) may be used to dope the titanium site with “acceptors” to improve insulation resistance of the dielectric.

As used herein, “barium titanate-based dielectric precursor layer” means a layer that when annealed forms dielectric comprised of barium titanate, wherein the barium may be partially replaced by valence 2 elements such as lead, strontium, calcium and the like, and wherein the titanium may be partially replaced by valance 4 elements such as tin, zirconium and hafnium (i.e., a “barium titanate-based dielectric”). The “barium titanate-based dielectric precursor layer” may additionally include minor amounts of acceptor and donor dopants, and the “barium titanate-based dielectric” may include minor amounts of such acceptor and donor dopants.

To form the dielectric, a dielectric precursor layer is formed over the base metal foil by a thin-film deposition technique such as sputtering, laser ablation, chemical vapor deposition, or chemical solution deposition (CSD). The dielectric precursor layer is most typically formed by CSD wherein a film of a dielectric precursor solution is coated on the base metal foil. The coating may be performed by spraying, spin coating, roller coating, rod coating or the like. CSD techniques are desirable due to their simplicity and low cost.

The chemical precursor solution from which a BaTiO₃ based dielectric can be prepared may comprise barium acetate, barium propionate, acetylacetone stabilized titanium butoxide, titanium isopropoxide, acetylacetone, acetic acid, and diethanolamine. Other chemistries are feasible. A 0.38 mol solution of “undoped” or pure barium titanate precursor solution may be prepared from the following:

| | | |
|---|---|---|
| Barium acetate | 2.6 | g |
| Titanium isopropoxide | 2.9 | ml |
| Acetylacetone | 2.0 | g |
| Acetic acid | 22.1 | g |
| Diethanolamine | 0.3 | g |

The precursor solution may or may not contain a dopant source or sources of other substitutions for barium or titanium as previously discussed. For a stable dielectric precursor solution, the above chemicals should be free of water. Water de-stabilizes the precursor composition, resulting in precipitation of titanium oxide. It is therefore important to prepare and deposit the dielectric precursor solution in relatively low humidity environments, such as less than about 40% relative humidity. Once the dielectric precursor solution has been fully deposited on a foil and dried, it is less susceptible to humidity.

In step S130, the dielectric precursor solution is dried to form a dielectric precursor layer on the base metal foil. Drying may be performed, for example, at a temperature of between 100° C. and 300° C. in air for about five to ten minutes. Drying may be accomplished by placing the coated foil on a hot plate or in an oven. Drying evaporates the solvents in the precursor solution.

In step S140, the dried dielectric precursor layer and base metal foil are pre-annealed. Pre-annealing may be accomplished by placing the coated foil on a hot plate or by heating the coated foil in a furnace. Pre-annealing may also be performed in a controlled atmosphere to limit oxidation of the underlying metal foil. Pre-annealing is preferably repeated after each layer has been dried but pre-annealing may be undertaken for two or more dried dielectric precursor layers at one time depending upon the dried dielectric precursor layer thickness. During pre-annealing, the dielectric precursor material is heated or baked for a short period of time at a temperature sufficient to remove the organic content of the dried dielectric precursor by decomposition, hydrolysis and/or pyrolysis. The pre-annealing can be combined with the drying step, but pre-annealing is more typically performed on the dried dielectric precursor layer. The pre-annealing temperature should be below the temperature at which crystallization of the dielectric precursor is intitiated. The pre-annealing temperature for a barium titanate-based dielectric precursor is preferably in the range of 300° C. and 530° C., and more preferably in the range of 330° C. to 500° C., and most preferably in the range of 350° C. to 450° C. The pre-annealing is conducted for a period of about ten to twenty minutes.

Pre-annealing of the dried dielectric precursor layer removes the residual organic material or polymer content of the dried dielectric precursor layer, thus, converting the dried dielectric precursor layer to an amorphous inorganic layer. The pre-annealing step is conducted under conditions that remove the organic content from the dielectric precursor layer while avoiding oxidation of the underlying foil and avoiding or minimizing the initiating of crystallization of the dielectric precursor material. Consecutive dielectric precursor layer deposition, drying and pre-annealing steps may be used to coat the base metal foil substrate to a desired thickness. Eight to twenty coating steps, for example, may be used to produce a final annealed dielectric thickness of 0.7-1.0 micrometer. More or fewer coats may be used if a different final annealed thickness is desired.

According to the method of the invention, the pre-annealed dielectric precursor material is subjected to rapid thermal annealing in a suitable rapid thermal anneal furnace. Rapid thermal anneal furnaces generally heat parts by infrared lamps. Infrared heating of a low thermal mass part allows for the part to attain the peak anneal temperature within a period of a few seconds. A dielectric precursor material on a metallic foil is such a low thermal mass. One suitable rapid thermal anneal furnace is a Jipelec Jet First 200C furnace, sold by Qualiflow Therm S.A.S. In step S150, the dielectric precursor material is rapid thermal annealed to produce the dielectric. In the rapid thermal annealing, the barium-titanate based dielectric precursor is heated from a temperature between room temperature and 530° C. to a temperature of more than 800° C. in less than 10 seconds, and more preferably less than 5 seconds, and most preferably in 1 to 2 seconds. In one embodiment, the pre-annealed barium-titanate based dielectric precursor material is heated from room temperature to an annealing temperature of more than 850° C. in less than 5 seconds. In another embodiment, the pre-annealed barium-titanate based dielectric precursor material is heated from about 400° C. to an annealing temperature of more than 850° C. in less than 5 seconds, and more preferably in about 1 to 3 seconds. During the rapid thermal annealing, the dielectric precursor material is heated to the annealing temperature at a rate in the range of 100° C. to 200° C. per second, but higher heating rates can be used. The rapid heating rate rapidly passes the barium titanate-based dielectric precursor material through the temperature range where crystallization initiation occurs, thereby minimizing the number of crystallization sites. Minimizing the crystallization sites allows for rapid grain growth at the annealing temperature so as to obtain large grains. The annealing temperature is typically in the range of 800° C. to 1200° C., but may be as high as 1300° C.

In a preferred embodiment, the rapid thermal annealing is undertaken in a vacuum atmosphere having an oxygen partial pressure of less than about 1×10⁻⁶ atmospheres. The rapid thermal annealing heating is typically conducted by subjecting the dielectric precursor material to infrared radiation from an IR rapid heating device, but may otherwise be conducted by inserting a foil directly into the hot zone of a conventional tube type anneal furnace.

Temperatures for annealing the dielectric may range from 800° C. to 1300° C. depending on the melting point of the underlying metal foil and the dielectric micro-structure desired. The annealing time is normally between about 10 to 45 minutes. For example, firing a dielectric on nickel foil may be undertaken at temperatures as high as 1200° C. but for copper foil, firing is limited to about 1050° C. The peak annealing temperature is typically maintained for between 10 and 50 minutes but could be shorter or longer depending on the dielectric precursor material used.

As with the rapid thermal annealing of the dielectric, the annealing of the dielectric may also be conducted in a low oxygen partial pressure environment to protect the underlying base metal foil from oxidation. The exact atmosphere required will depend upon the temperature and the thermodynamics and kinetics of oxidation of the underlaying metal foil. For nickel, a partial pressure of oxygen of less than about 1×10⁻⁶ atmospheres is generally suitable. This may be accomplished by evacuating the furnace to a total pressure of approximately 6.6×10⁻⁴ atmospheres and bleeding 0.1% oxygen doped argon gas into the chamber at a rate of 40 standard cubic centimeters per minute (sccm) while the vacuum pump is running. When firing the dielectric, it is desirable to have the highest PO₂ level feasible in order to minimize oxygen vacancy and free electron formation due to reduction of the dielectric. The PO₂ level should be set at the highest level possible that will not cause significant oxidation of the metal foil. A small amount of oxidation of the metal foil may be acceptable and, therefore, the PO₂ level for the atmosphere during firing of the dielectric may be higher than that calculated to entirely protect the foil from oxidation. However, if the level of oxidation is too high, a thick oxide layer will be formed on the underlying metal foil which reduces the effective dielectric constant of the dielectric. The optimum oxygen partial pressure depends on the metal foil, dopant type and concentration if used, and the firing temperature. The desired oxygen partial pressure may be achieved by use of suitable gas combinations or vacuum. Such combinations include pure nitrogen, nitrogen/forming gas/water mixtures, nitrogen/forming gas mixtures, nitrogen/forming gas/carbon dioxide mixtures, carbon dioxide/carbon monoxide mixtures, etc. A typical forming gas is a mixture of 99% nitrogen and 1% hydrogen gas.

The disclosed method for making a dielectric provides a means for forming large area thin-film dielectrics on base metal foils of large areas. With the disclosed method, fired-on-foil dielectrics with areas greater than 4 cm², or greater than 10 cm², or greater than 25 cm², and even as large as 100 cm² have been obtained with uniform good physical and electrical properties. When a large area 100 cm² annealed dielectric with good physical and electrical properties is obtained, multiple separate 1 cm by 1 cm or larger electrodes are deposited on to the dielectric to form multiple capacitors each with good physical and electrical properties.

The large area thin-film barium titanate based dielectrics made by the method of the invention exhibit desirable physical and electrical properties. One desirable physical property is a dense microstructure. Another desirable physical property is the resultant average dielectric grain sizes that are on average in the range of 0.05 to 0.4 microns, and more preferably in the range of 0.1 to 0.2 microns. The optimum high K phase in barium titanate-based dielectrics is achieved when grain sizes exceed 0.1 micron. One desirable electrical property resulting from this large grain size is an average capacitance density of approximately 2.0 μF/cm². Another desirable electrical property obtained is a high normalized insulation resistance of greater than 1×10⁷ ohms.cm².

In step S160, top electrodes are formed over the resulting dielectric. The top electrode can be formed by, for example, sputtering, evaporation, chemical vapor deposition, electro-less plating, printing or other suitable deposition methods. In one embodiment, a sputtered copper electrode is used. Other suitable materials for the top electrode include nickel, platinum, palladium, and combinations thereof. The top electrode(s) may be plated with copper to increase thickness, if desired. The base foil, the dielectric, and the top electrode form a capacitor that can be embedded in a printed wiring board.

The following examples illustrate the favorable properties that can be obtained in dielectrics prepared according to the disclosed method, and the capacitors prepared according to the disclosed method.

### Example 1

A 0.38 mol solution of “undoped” or pure barium titanate precursor solution was prepared from the following:

| | | |
|---|---|---|
| Barium acetate | 2.6 | g |
| Titanium isopropoxide | 2.9 | ml |
| Acetylacetone | 2.0 | g |
| Acetic acid | 22.1 | g |
| Diethanolamine | 0.3 | g |

A 2 inch by 2 inch 37 micrometer thick nickel foil was pre-baked and entirely coated with the barium titanate dielectric precursor solution. The coating was accomplished by spraying the precursor solution on to the surface of the metal foil. The precursor solution was then dried in air on a hot plate at 150° C. for 5 minutes and pre-annealed at 400° C. for fifteen minutes in air. The process of coating deposition, drying and pre-annealing was repeated until 11 layers had been deposited. Several pieces of the same nickel foil were coated in this same manner. The multiple dried and pre-annealed dielectric precursor layers on the nickel foil were fired in a rapid thermal anneal furnace. The coated foil was placed into the furnace and the atmosphere evacuated to a total pressure of approximately 6.6×10⁻⁴ atmospheres. A 0.1% oxygen doped argon gas was then bled into the chamber at a rate of 40 sccm while the vacuum pump was running. Then the dielectric precursor material was heated to 390° C. at 1° C./second and kept at 400° C. for 10 minutes. The dielectric precursor material on the coated foil was then rapidly heated from 390° C. to a target temperature of 875° C. in about 7 seconds with an overshoot to 950° C. The heating rate to 950° C. was nominally around 80° C./second. In a portion of the 7-second ramp, the ramp rate was as high as 125° C./second. The coated foil was held at 875° C. for an annealing time of 45 minutes. The furnace was allowed to cool after annealing. The annealed dielectric had an area of 2 inches by 2 inches.

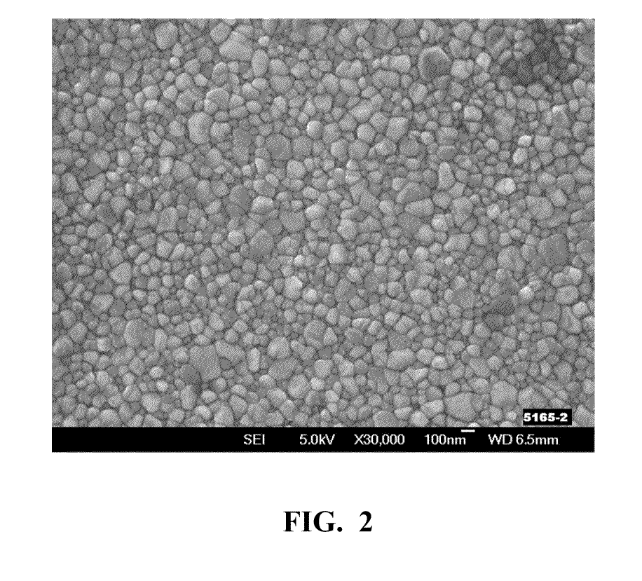

FIG. 2 is a scanning electron micrograph of the surface of the rapid thermal annealed dielectric. The surface exhibits no visible porosity and has an average grain size of approximately 110 nm (0.11 micrometer) as measured by the intercept method.

Copper electrodes with an area of 9 to 49 mm² were formed on the annealed dielectric by sputtering copper through a mask. Twenty-four good capacitors were produced. The capacitors ranged in capacitance density from 1.4 to 2.7 μF/cm² with an average capacitance density of 2.06 μF/cm². Normalized insulation resistance of the capacitors ranged from 1.2×10⁷ ohms.cm² to 1.8×10⁸ ohms.cm² and averaged 5.1×10⁷ ohms.cm².

### Example 2A

A 0.2 mol solution of “undoped” or pure barium titanate precursor solution was prepared from the following:

| | | |
|---|---|---|
| Barium hydroxide octahydrate | 31.54 | g |
| Titanium (IV) n-butoxide | 34.03 | g |
| 1-butanol | 222.6 | ml |
| Acetyl-acetone | 20.02 | g |
| Propionic acid | 222.6 | ml |

A 37.5 micrometer thick nickel foil was cut into 4 samples that were each squares of 2 inches by 2 inches. The foil squares were pre-baked at 900° C. for 30 minutes in a forming gas (95% N₂/5% H₂) and then cooled. The nickel foil was entirely coated with the barium titanate dielectric precursor solution. The coating was accomplished by spraying the precursor solution on to the surface of the metal foil. The precursor solution was then dried in air on a hot plate at 150° C. for 5 minutes and then pre-annealed at 400° C. for fifteen minutes in air. The process of coating deposition, drying and pre-annealing was repeated until 11 layers had been deposited. Several pieces of the same nickel foil were coated in this same manner.

The multiple dried and pre-annealed dielectric precursor layers on the nickel foil were fired in a rapid thermal anneal furnace. The coated foil was placed into the furnace and the atmosphere was evacuated to a total pressure of approximately 7×10⁻⁴ atmospheres. A 0.1% oxygen doped argon gas was then bled into the chamber at a rate of 38 sccm while the vacuum pump was running, so as to provide an oxygen partial pressure of 7×10⁻⁷ atm. The foil and dielectric precursor material were gradually heated to about 400° C. over a period of 6 minutes and kept at that temperature for 10 minutes. The dielectric precursor material on the coated foil was then rapidly heated from 400° C. to a target temperature of 875° C. in about 2.3 seconds at a firing ramp rate of 200° C. per second with an overshoot to 912° C. The coated foil was held at 875° C. for an annealing time of 45 minutes. The furnace was allowed to cool after annealing.

The annealed dielectric had a film thickness of 0.7 micrometers. A scanning electron micrograph of the surface of one of the rapid thermal annealed dielectric was made. The surface exhibited no visible porosity and has an average grain size of approximately 95 nm (0.095 micrometer) as measured by the intercept method.

Square copper electrodes with a thickness of 0.1 micrometer and an area for from 9 to 49 mm² were formed on the annealed dielectric samples by sputtering copper through a mask. A total of thirty good capacitors were formed from the annealed dielectrics on the four foil samples. The capacitors ranged in capacitance density from 1.4 to 2.7 μF/cm² with an average capacitance density of 2.05 μF/cm². Normalized insulation resistance of the capacitors ranged from 10^{7.0} ohms.cm² to 10^{8.2} ohms.cm² and averaged 10^{7.6} ohms.cm².

### Comparative Example 2B

A 0.2 mol solution of “undoped” or pure barium titanate precursor solution was prepared from the following:

| | | |
|---|---|---|
| Barium hydroxide octahydrate | 31.54 | g |
| Titanium (IV) n-butoxide | 34.03 | g |
| 1-butanol | 222.6 | ml |
| Acetyl-acetone | 20.02 | g |
| Propionic acid | 222.6 | ml |

A 37.5 micrometer thick nickel foil of approximately 5 inches by 5 inches was provided. The foil was pre-baked at 1000° C. for 90 minutes in a forming gas (1% N₂/99% H₂) and then cooled. The nickel foil was entirely coated with the barium titanate dielectric precursor solution. The coating was accomplished by spraying the precursor solution on to the surface of the metal foil. The precursor solution was then dried in air on a hot plate at 150° C. for 5 minutes and then pre-annealed at 400° C. for fifteen minutes in air. The process of coating deposition, drying and pre-annealing was repeated until 5 layers had been deposited on the foil.

The multiple dried and pre-annealed dielectric precursor layers on the nickel foil were fired in a heated vacuum chamber. The coated foil was placed into the chamber and the atmosphere was evacuated to a total pressure of approximately 1.3×10⁻⁶ atmospheres, so as to provide an oxygen partial pressure of 1×10⁻⁸ atm. The foil and dielectric precursor material were gradually heated to about the annealing temperature of 850° C. over a period of 1.5 minutes. The coated foil was held at 850° C. for an annealing time of 30 minutes. The chamber was allowed to cool after annealing.

The annealed dielectric had a film thickness of 0.6 micrometers. A scanning electron micrograph of the surface of one of the rapid thermal annealed dielectric was made. The surface exhibited no visible porosity and has an average grain size of approximately 13 nm (0.013 micrometer) as measured by the intercept method.

Square copper electrodes with a thickness of 0.1 micrometer and an area of 9 to 49 mm² were formed on the annealed dielectric sample by sputtering copper through a mask. Nine good capacitors were produced. The capacitors ranged in capacitance density from 0.27 to 0.47 μF/cm² with an average capacitance density of 0.36 μF/cm².

What is claimed is:

1. A method of making a thin-film dielectric, comprising:
providing a base metal foil;
forming a barium titanate-based dielectric precursor layer over a base metal foil;
pre-annealing the dielectric precursor layer and base metal foil at a temperature in the range of 300° C. to 530° C.; and
rapidly heating the pre-annealed dielectric precursor layer from a temperature of less than 530° C. to an annealing temperature of more than 800° C. in less than 15 seconds; and
annealing the dielectric at the annealing temperature of more than 800° C. to form a crystalline barium titanate-based dielectric on the base metal foil, wherein the annealed crystalline barium titanate-based dielectric has grains with an average grain size that is equal to or greater than 50 nanometers.

2. The method of claim 1 wherein step of rapidly heating the pre-annealed dielectric occurs at a heating rate in the range of 100° C. per second to 200° C. per second.

3. The method of claim 1 wherein the pre-annealed dielectric precursor layer is rapidly heated from a temperature of less than 530° C. to an annealing temperature of more than 800° C. in less than 5 seconds.

4. The method of claim 1 wherein the pre-annealed dielectric precursor layer is rapidly heated from a temperature of less than 530° C. to an annealing temperature of more than 800° C. in a period in the range of from 1 to 3 seconds.

5. The method of making a dielectric of claim 1, wherein the annealing is conducted in a vacuum atmosphere having an oxygen partial pressure of less than about 10⁻⁶ atmospheres.

6. The method of making a dielectric of claim 1 wherein the annealing temperature is in the range of 800° C. to 1200° C., and the annealing period is in the range of 10 to 30 minutes.

7. The method of making a dielectric of claim 1 wherein the base metal foil comprises a metal foil having a nickel surface.

8. The method of making a dielectric of claim 1 wherein forming the dielectric precursor layer comprises coating a surface of the base metal foil with a dielectric precursor solution comprising a first component selected from barium isopropoxide, barium acetate, barium propionate, or mixtures thereof and a second component selected from titanium isopropoxide, titanium butoxide, acetylacetone stabilized titanium butoxide, or mixtures thereof.

9. The method of making a dielectric of claim 1, wherein after pre-annealing of the dielectric precursor layer, an additional dielectric precursor layer is formed over the pre-annealed dielectric precursor layer, and wherein said additional dielectric precursor layer is pre-annealed at a temperature in the range of 300° to 530° C.

10. The method of making a dielectric of claim 1, wherein the annealing results in a thin-film dielectric with a thickness of less than 2 microns and comprising crystalline barium titanate or crystalline barium strontium titanate.

11. The method of claim 1 wherein the annealed dielectric has an average grain size that with an range defined by and including any two of the following sizes: 50 nanometers; 100 nanometers; 200 nanometers and 400 nanometers.

12. The method of making a dielectric of claim 1, wherein the dielectric has an area of greater than 4 cm².

13. A method of making a capacitor, comprising:
providing a base metal foil;
forming a barium titanate-based dielectric precursor layer over a base metal foil;
pre-annealing the dielectric precursor layer and base metal foil at a temperature in the range of 300° C. to 530° C.; and
rapidly heating the pre-annealed dielectric precursor layer from a temperature of less than 530° C. to an annealing temperature of more than 800° C. in less than 10 seconds;
annealing the dielectric at the annealing temperature of more than 800° C. to form a crystalline barium titanate dielectric on the base metal foil, wherein the crystalline barium titanate dielectric has an average grain size that greater or equal to 50 nanometers; and
forming a second conductive layer over the dielectric, wherein the metal foil, the dielectric, and the second conductive layer to form the capacitor.

14. The method of claim 13, wherein the second conductive layer is deposited by sputtering.

15. The method of claim 13 wherein the pre-annealed dielectric precursor layer is rapidly heated from a temperature of less than 530° C. to an annealing temperature of more than 800° C. in less than 5 seconds.

16. The method of claim 13 wherein the pre-annealed dielectric precursor layer is rapidly heated from a temperature of less than 530° C. to an annealing temperature of more than 800° C. in a period in the range of from 1 to 3 seconds.

17. The method of claim 13 wherein the annealing is conducted in a vacuum atmosphere having an oxygen partial pressure of less than about 10⁻⁶ atmospheres.

18. The method of making a dielectric of claim 13 wherein the annealing temperature is in the range of 800° C. to 1200° C.

19. The method of making a dielectric of claim 13 wherein the base metal foil comprises a metal foil having a nickel surface.

20. The method of claim 13 wherein forming the dielectric precursor layer comprises coating a surface of the base metal foil with a dielectric precursor solution comprising a first component selected from barium isopropoxide, barium acetate, barium propionate, or mixtures thereof and a second component selected from titanium isopropoxide, titanium butoxide, acetylacetone stabilized titanium butoxide, or mixtures thereof.

21. The method of claim 13 wherein the annealing results in a thin-film dielectric with a thickness of less than 2 microns and comprising crystalline barium titanate or crystalline barium strontium titanate.

22. The method of claim 13 wherein the capacitor has an average capacitance density of about 2.0 μF/cm².
